(19) United States
(12) Patent Application Publication
(10) Pub. No.: US 2012/0073680 A1
(43) Pub. Date: Mar. 29, 2012

(54) SAFETY DEVICE FOR PRESSURIZED GAS

(75) Inventors: Simon Jallais, Chaville (FR); Vladimir Hasanov, Rueil-Malmaison, AZ (US); Joseph Pierquin, Molsheim (FR); Philippe Pisot, L'Isle Adam (FR); Sylvain Gerard, Saint-Cloud (FR); Hervé Challiol, Gif-Sur-Yvette (FR); Alexandre Morainville, Champigny-Sur-Marne (FR)

(73) Assignee: L'Air Liquide Societe Annonyme pour ;'Etude et Explotitation des Procedes Georges Claude, Paris (FR)

(21) Appl. No.: 13/320,776

(22) PCT Filed: May 7, 2010
(86) PCT No.: PCT/FR10/50884

§ 371 Date: Nov. 16, 2011

(30) Foreign Application Priority Data
May 27, 2009 (FR) 0953468

(51) Int. Cl. F16K 21/04

(52) U.S. Cl. 137/511

(57) ABSTRACT

The invention relates to a safety device constituting a valve for releasing pressurized gas in the event of a dangerous situation, including a body defining a gas flow channel extending in a longitudinal direction between a first upstream end to be brought into contact with a pressurized gas source (G) and a second downstream end to be brought into contact with the outer atmosphere, wherein the device includes a plug located in the channel for preventing the flow of gas between the upstream end and the downstream end in a normal situation, the plug being shaped so as to release the passage for the gas in the event of a dangerous situation in which it is subjected to a pressure and/or a temperature exceeding a predetermined threshold, characterized in that, from the upstream direction toward downstream direction, the channel includes two upstream and downstream adjacent flow portions, respectively, having different respective transverse dimensions (d, D), the ratio D/d between the transverse dimension D of the downstream portion and the transverse dimension d of the upstream portion being between 1.4 and 11, and in that the junction between the two adjacent portions forms a discontinuity in the transverse dimension of the channel, and in that the ratio L/D between the length L of the downstream portion and the transverse dimension D of said downstream portion is between 15 and 100.

### CROSS REFERENCE TO RELATED APPLICATIONS

This application is a 371 of International PCT Application PCT/FR2010/050884, filed May 7, 2010, which claims priority to French Application No. 0953468, filed May 26, 2009, the entire contents of which are incorporated herein by reference.

### BACKGROUND

The present invention relates to a safety device for pressurized gas.

The invention relates more particularly to a safety device that makes it possible to prevent a gas storage facility or pipeline carrying gas, notably flammable gas such as hydrogen, from exploding.

### SUMMARY

The invention thus relates to a safety device forming a relief valve that releases a gas under pressure in the event of a dangerous situation, comprising a body defining a channel for the flow of gas running in a longitudinal direction between an upstream first end intended to be placed in contact with a source of gas under pressure and a downstream second end intended to be placed in contact with the exterior atmosphere, the device comprising a plug situated on the channel to prevent gas from flowing between the upstream end and the downstream end under normal situations, the plug being configured to open the passage to the gas in the event of a dangerous situation when subjected to a pressure and/or temperature that exceed a determined threshold.

Hydrogen storage cylinders used in mobile applications (vehicles) are generally fitted with a device that allows the gaseous contents of the cylinder to be emptied if this cylinder is involved in a fire, in order thus to prevent it from bursting. This safety device generally uses a thermal fuse (for example a metal eutectic), which melts under the action of the temperature of the fire to create a controlled leak of gas which empties the cylinder and thus prevents it from bursting. In many instances of fire, as the fuse opens, the hydrogen catches fire and creates a very long flame on the outside of the cylinder.

In some instances, the opening of the fuse discharges the hydrogen but this hydrogen does not catch fire. The hydrogen then mixes with the ambient air, thereby forming a cloud which may be of large volume. Such a cloud of flammable gas is likely to explode, and this may prove particularly hazardous in confined and obstructed spaces (for example underground car parks or tunnels). In this respect, it may be preferable to form a flame (even a very long flame) rather than a gas cloud. This is because the effects associated with a flame (radiation in particular) may be preferable to those associated with the exploding of a gas cloud.

Documents FR 2 725 008 and U.S. Pat. No. 2,557,199 describe safety systems which ensure that the gas released is ignited using an ignition means of electrical or catalytic type.

It is one object of the invention to propose a safety device which, when activated to release the gas, encourages the creation of a flame as the gas is emptied (particularly in the case of hydrogen).

To this end, the device according to the invention, in other respects in accordance with the generic definition given thereof in the above preamble, is essentially characterized in that, from upstream to downstream, the channel comprises two adjacent flow portions, these respectively being an upstream and a downstream flow portion, the respective transverse dimensions (d, D) of which are different, the ratio D/d between the transverse dimension D of the downstream portion and the transverse dimension d of the upstream portion being comprised between 1.4 and 11; and in that the junction between the two adjacent portions forms a discontinuity in the transverse dimension of the channel, and in that the ratio L/D between the length L of the downstream portion and the transverse dimension D of this downstream portion is comprised between 15 and 100.

Moreover, some embodiments of the invention may comprise one or more of the following features:

the ratio D/d between the transverse dimension D of the downstream portion and the transverse dimension of the upstream portion is comprised between 1.5 and 10, and preferably comprised between 1.8 and 2.2,

the ratio LID between the length L of the downstream portion and the transverse dimension D of this downstream second portion is comprised between 20 and 60 and preferably between 38 and 42,

the upstream end of the upstream portion is intended to be placed in contact with a source of gas under pressure,

the downstream end of the downstream portion is intended to be placed in contact with the atmosphere,

the respective transverse dimensions (d, D) of the two portions are the respective diameters or mean diameters of said portions,

at least part of the downstream portion comprises a reserve of gas that is enriched in oxygen with respect to the atmosphere, said reserve being kept in the downstream portion by at least one retaining member such as a membrane, the retaining membrane being configured to open up the passage to the gas and allow mixing with the enriched gas of the reserve when subjected to a pressure and/or to a temperature that exceed a determined threshold,

the downstream portion comprises, upstream of the downstream end, at least one orifice providing communication between the downstream portion and the exterior atmosphere, so as to form a spontaneous air induction system if there is circulation of gas under pressure originating from a source,

the body defining the channel is formed of at least two separable components.

The invention also relates to a container of pressurized gas, notably of flammable gas containing hydrogen, comprising at least one safety device according to any one of the above or following features.

The invention may also relate to any alternative device or method comprising any combination of the above or following features.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 is a schematic view in longitudinal section illustrating the structure and operation of a safety device as applied to a storage container,

FIG. 2 is a schematic view in longitudinal section illustrating a second embodiment of the safety device according to the invention,

FIG. 3 is a view in longitudinal section illustrating one example of the structure of the safety device according to the invention.

### DESCRIPTION OF PREFERRED EMBODIMENTS

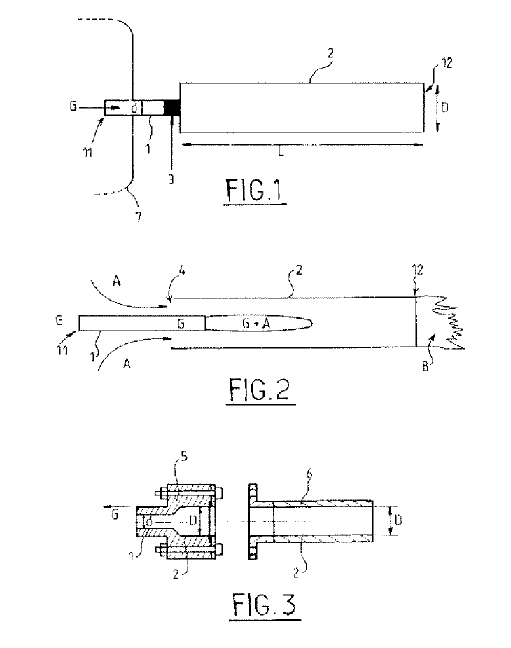

The embodiment of a safety device illustrated in FIG. 1 comprises a body defining a channel 1, 2 for the flow of gas running in a longitudinal direction between an upstream first end 11 and a downstream second end 12. The upstream end 11 is in contact with the gas G under pressure. The downstream end 12 for its part is in contact with the exterior atmosphere.

The safety device can be mounted on any type of gas storage facility (pressurized container, cylinder, pipeline carrying gas, etc.). The safety device can be mounted directly on the storage facility 7 or on an auxiliary component such as a cylinder tap or valve or any other component used to control the pressurized gas.

Conventionally, the device comprises a plug 3 situated on the channel 1, 2 to prevent gas from flowing between the upstream end 11 and the downstream end 12 under normal situations. The plug 3 may comprise at least one out of: a diaphragm, a eutectic fuse or any other appropriate system creating a barrier against the gas below a pressure and/or temperature threshold.

Conventionally, the plug 3 is configured to open the passage to the gas in the event of a dangerous situation, for example when subjected to a pressure and/or to a temperature that exceed a determined threshold.

According to one advantageous special feature, from upstream to downstream, the channel 1, 2 comprises two adjacent flow portions, these respectively being an upstream flow portion 1 and a downstream flow portion 2, the respective transverse dimensions d, D of which are different and defined as follows: the ratio D/d between the transverse dimension D of the downstream portion 2 and the transverse dimension d of the upstream portion 1 is comprised between 1.4 and 11.

The ratio D/d between the transverse dimension D of the downstream portion 2 and the transverse dimension d of the upstream portion 1 is more preferably comprised between 1.5 and 10 and more preferably still comprised between 1.9 and 2.2. For example, the ratio D/d between the transverse dimension D of the downstream portion 2 and the transverse dimension d of the upstream portion 1 is equal to two. The plug 3 may be situated at or near the junction between the two portions 1, 2.

The junction between the two adjacent portions 1, 2 preferably forms a discontinuity in the transverse dimensions of the channel 1, 2. This sudden widening of the channel thus focuses the shockwaves, which mixes the gas with the air while also raising it to a high enough temperature that the gas-air premixture self-ignites.

Moreover, the ratio L/D between the length L of the downstream portion 2 and the transverse dimension D of this downstream portion 2 is comprised between 15 and 100.

The ratio L/D between the length L of the downstream portion 2 and the transverse dimension D of this downstream portion 2 is, for example, comprised between 20 and 60 and preferably between 38 and 42 and more preferably still of the order of 40.

The respective transverse dimensions d, D of the portions 1, 2 of the channel are, for example, respective diameters or mean diameters of said portions 1, 2. In particular, when the portions 1, 2 of the channel are cylindrical, the respective transverse dimensions d, D are the relevant diameters.

Such a configuration notably encourages the spontaneous ignition of the hydrogen gas or mixture containing hydrogen.

To encourage spontaneous ignition still further, it is possible to replace at least some of the air contained in the downstream portion 2 with oxygen or oxygen-enriched air. For example, the downstream portion 2 may be sealed by one or more fluidtight membranes to contain the oxygen. In the event of activation (the opening of the plug 3), the membrane is ruptured and releases the oxygen which mixes with the flammable gas released. The oxygen then acts as an activator to activate the ignition of the hydrogen (or other gas). In this way, it is possible further to reduce the spontaneous-ignition time for the gas released (this ignition time may thus notably be reduced by a factor of as high as ten).

When the flammable gas is released, it is also possible to use the speed at which the gas flows to create an entrainment of air A to form a premixture (G+A) in the device. To do that, and as illustrated schematically in FIG. 2, orifices 4 communicating with the atmosphere may be provided in the downstream portion 2 of the channel. The flow of the air A aspirated into the downstream portion 2 is symbolized by arrows. This encourages the creation of a flame 8.

Likewise, if it is desired to shorten the length of the flame generated, it is possible to conceive of a system that causes the gas G (or the air A) to rotate about the longitudinal flow axis. For example, fins may give the gas G or the mixture G+A a rotational movement to encourage mixing and shorten the flame.

FIG. 3 illustrates a nonlimiting example of one possible structure for the gas flow channel. The gas flow channel 1, 2 may thus be formed of two tubular components 5, 6 that can be assembled removably (for example using screws). The upstream portion 1 and possibly part of the downstream portion 2 may be formed in a first tube 5. It being possible for the downstream portion 2 to be formed in a second tube 6.

For example, the upstream portion 1 may be cylindrical and have a diameter d comprised between 0.1 and 15 mm and preferably between 2.2 and 10 mm, and more preferably still equal to 5 mm. The downstream portion 2 is preferably cylindrical and may have a diameter D comprised between 3 and 50 mm and preferably between 5 and 15 mm and more preferably still equal to 10 mm. For preference, the downstream portion 2 has a length comprised between 100 and 300 mm. With this configuration, for gas, notably hydrogen, pressures comprised between 200 and 700 bar, spontaneous ignition is more greatly encouraged than in the prior art. It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1-10. (canceled)

11. A safety device forming a relief valve that releases a gas under pressure in the event of a dangerous situation, the safety device comprising
a) a body defining a channel (1, 2) configured to be capable of directing a flow of gas in a longitudinal direction between
A) an upstream first end (11) adapted to be placed in contact with a source of gas (G) under pressure and
B) a downstream second end (12) adapted to be placed in contact with the exterior atmosphere,
b) a plug (3) situated on the channel (1, 2) configured to prevent a gas from flowing between the upstream end (11) and the downstream end (12) under normal situations, the plug (3) being configured to open the passage to the gas when subjected to a pressure and/or temperature that exceed a determined threshold,
c) wherein, from upstream to downstream, the channel (1, 2) comprises two adjacent flow portions, these respectively being an upstream and a downstream flow portion, the respective transverse dimensions (d, D) of which are different, with a ratio (D/d) between the transverse dimension D of the downstream portion (2) and the transverse dimension d of the upstream portion (1) being from 1.4 to 11;
d) wherein a junction between the two adjacent portions (1, 2) forms a discontinuity in the transverse dimension of the channel (1, 2), with a ratio (L/D) between the length L of the downstream portion (2) and the transverse dimension D of this downstream portion (2) being from 5 to 100.

12. The device of claim 11, wherein the ratio D/d between the transverse dimension D of the downstream portion (2) and the transverse dimension of the upstream portion (1) is between 1.5 and 10.

13. The device of claim 11, wherein the ratio D/d between the transverse dimension D of the downstream portion (2) and the transverse dimension of the upstream portion (1) is between 1.8 and 2.2.

14. The device of claim 11, wherein the ratio L/D between the length L of the downstream portion (2) and the transverse dimension D of this downstream second portion (2) is between 20 and 60.

15. The device of claim 11, wherein the upstream end (11) of the upstream portion (1) is adapted to be placed in contact with a source of gas (G) under pressure.

16. The device of claim 11, wherein the downstream end (12) of the downstream portion (2) is adapted to be placed in contact with the atmosphere.

17. The device of claim 11, wherein the respective transverse dimensions (d, D) of the two portions (1, 2) are the respective diameters or mean diameters of said portions (1, 2).

18. The device of claim 11, wherein at least part of the downstream portion (2) comprises a reserve of gas that is enriched in oxygen with respect to the atmosphere, said reserve being kept in the downstream portion (2) by at least one retaining member, the retaining membrane being configured to open up the passage to the gas and allow mixing with the enriched gas of the reserve when subjected to a pressure and/or to a temperature that exceed a predetermined threshold.

19. The device of claim 11, wherein the downstream portion (2) comprises, upstream of the downstream end (12), at least one orifice (4) providing communication between the downstream portion (2) and the exterior atmosphere, so as to form a spontaneous air (A) induction system if there is circulation of gas (G) under pressure originating from a source.

20. The device of claim 11, wherein the body defining the channel (1, 2) is formed of at least two separable components (5, 6).
